(19) United States
(12) Patent Application Publication
(10) Pub. No.: US 2013/0219177 A1
(43) Pub. Date: Aug. 22, 2013

(54) SECURE DATA PROCESSING DEVICE AND METHOD

(71) Applicant: SAMSUNG ELECTRONICS CO. LTD., (US)

(72) Inventors: Yang-Soo LEE, Yongin-si (KR); Tae-In AN, Hwaseong-si (KR); Moon-Soo CHANG, Suwon-si (KR); Su-Hyung KIM, Seoul (KR); Seung-Bum LEE, Hwaseong-si (KR)

(73) Assignee: SAMSUNG ELECTRONICS CO. LTD., Suwon-si (KR)

(21) Appl. No.: 13/770,398

(22) Filed: Feb. 19, 2013

(30) Foreign Application Priority Data
Feb. 16, 2012 (KR) 10-2012-0016080
Feb. 16, 2012 (KR) 10-2012-0016082

(51) Int. Cl. G06F 21/62

(52) U.S. Cl. CPC G06F 21/6218
USPC 713/166

(57) ABSTRACT

A secure data processing device is provided. The device includes a main Operating System (OS), a plurality of main processes which are executed under control of the main OS and which are associated with each other, a secure OS which is simultaneously operated with the main OS, and at least one secure process which is executed under control of the secure OS and which corresponds to at least one of the plurality of main processes. If at least one of the plurality of main processes is in an abnormal operation state, an operation of the least one secure process is interrupted and initialized according to a request of the main OS.

### PRIORITY

This application claims the benefit under 35 U.S.C. §119(a) of a Korean patent Application filed on Feb. 16, 2012 in the Korean Intellectual Property Office and assigned Serial No. 10-2012-0016080, and of a Korean patent Application filed on Feb. 16, 2012 in the Korean Intellectual Property Office and assigned Serial No. 10-2012-0016082, the entire disclosures of which are incorporated herein by reference.

### BACKGROUND OF THE INVENTION

1. Field of the Invention

The present invention relates to a data processing device. More particularly, the present invention relates to a data processing device and method capable of improving the security using a secure Operating System (OS) which is different from a main OS.

2. Description of the Related Art

Recently, mobile devices are required to process high-end services. For example, users may use the mobile devices to remotely download movies in a specific period of time, pay for the downloaded movies, perform various banking services, and perform various other services.

To provide these various services, the mobile devices adopt a Central Process Unit (CPU) and an Operating System (OS). Mobile devices according to the related art adopt an open OS to implement an open application program interface. The open OS is the core of the market competitiveness of mobile devices and mobile services. For example, the OS for the mobile devices has been strategically opened by major manufacturers and major suppliers. The application program interface, software development kit, and source file of such open OSs have also been opened to the public.

Mobile devices download a plurality of applications from/over the Internet. Such applications are often set to be used after the manufacturers of mobile devices or operating systems inspect/guarantee the quality of the applications. However, as a practical matter, all the features of a wide variety of applications may not be examined. Therefore, there has been a dramatic increase in the number of malicious codes targeting mobile devices. In particular, the mobile devices using an open OS are apt to be attacked by malware software. Therefore, in recent years, ways to use a secure OS have been sought.

As the mobile devices are required to process high-end services, a variety of digital content is provided to user devices such as Televisions (TVs), Personal Computer (PCs), portable devices, and the like. The digital content may include, for example, video files, audio files, and a variety of applications. With the increasing provision of the digital content, several ways to protect the intellectual property rights of the digital content have been proposed.

In particular, digital content protection technology, such as Digital Rights Management (DRM), has been proposed as one of the ways to protect digital content. The digital content protection technology is technology for continuously managing and protecting the intellectual property rights associated with digital content using encryption technology. Specifically, this digital content protection technology allows Content Providers (CPs) to securely deliver a variety of content to users and prevents the users, who have received the content, from illegally distributing the received content. This digital content protection technology may protect the information throughout the entire process including creation, distribution, consumption, and disposal of the digital content, and may also protect the user's rights online and offline.

In order for a user to enjoy the content (hereinafter referred to as ‘secure content’), to which the content protection technology is applied, on a user device, the user device needs to first access the system that provides the secure content, and then download the secure content, and metadata and a license for the secure content. The metadata is the data in which information about the secure content is stored, and the license is a decryption key used to decrypt the encrypted secure content, and data of the details specifying the access rights (for example, the number of accesses, an access period, and the like) to the content. If both the secure content and the license are stored in the user device through this process, the user may consume the secure content.

Therefore, a need exists for a secure data processing device and method which is robust against attacks of malicious codes. For example, a need exits for a secure data processing device and method capable of efficiently using system resources even if at least one process operates abnormally while a plurality of OSs are operating a plurality of processes.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a secure data processing device and method which is robust against attacks of malicious codes.

Another aspect of the present invention is to provide a secure data processing device and method capable of efficiently using system resources even if at least one process operates abnormally while a plurality of Operating Systems (OSs) are operating a plurality of processes.

In accordance with one aspect of the present invention, a secure data processing device is provided. The device includes a main OS, a plurality of main processes which are executed under control of the main OS and which are associated with each other, a secure OS which is simultaneously operated with the main OS, and at least one secure process which is executed under control of the secure OS and which corresponds to at least one of the plurality of main processes. If at least one of the plurality of main processes is in an abnormal operation state, an operation of the least one secure process is interrupted and initialized according to a request of the main OS.

In accordance with another aspect of the present invention, the secure OS may process data requiring security in a specific area of a memory, and the main OS may not access the specific area of the memory in which the secure OS processes data requiring security.

In accordance with another aspect of the present invention, each of the plurality of main processes may be at least one of a decryption process for decrypting content, a decoding process for decoding the content, a rendering process for outputting the content, and a User Interface (UI) process for providing the content to a user.

In accordance with another aspect of the present invention, the at least one secure process may be at least one of a decryption process for decrypting content, a decoding process for decoding the content, a rendering process for outputting the content, and a UI process for providing the content to a user.

In accordance with another aspect of the present invention, the secure data processing device may further include a secure communication unit for enabling switching between a normal mode in which the secure data processing device is executed by the main OS and a secure mode in which the secure data processing device is executed by the secure OS.

In accordance with another aspect of the present invention, the secure communication unit may separate a memory area accessible by the main OS and a memory area accessible by the secure OS in a hardware manner, using a predetermined bit.

In accordance with another aspect of the present invention, a secure data processing method is provided. The method includes detecting by a main OS that a first main process is operating abnormally, among a plurality of main processes which are executed under control of the main OS and which are associated with a secure OS that is simultaneously operated with the main OS, and interrupting and initializing an operation of at least one secure process which is executed under control of the secure OS that is simultaneously operated with the main OS, and which corresponds to at least one of the plurality of main processes.

In accordance with another aspect of the present invention, the secure data processing method may further include interrupting and initializing an operation of the plurality of main processes with the exception for the first main process.

In accordance with another aspect of the present invention, the secure data processing method may further include notifying, by the main OS, the abnormal operation of the first main process to the plurality of main processes with the exception of the first main process.

In accordance with another aspect of the present invention, the secure data processing method may further include requesting the main OS to interrupt and initialize the secure processes by any one of the plurality of main processes with the exception of the first main process.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic block diagram illustrating a mobile device, to which exemplary embodiments of the present invention are applicable;

FIG. 2 illustrates a configuration of a Central Processing Unit (CPU) in a controller according to an exemplary embodiment of the present invention;

FIG. 3 is a flowchart illustrating operations of a main unit and a secure unit upon a content execution request according to an exemplary embodiment of the present invention;

FIG. 4 is a flowchart illustrating a process of performing secure decryption on an audio stream according to an exemplary embodiment of the present invention; and

FIGS. 5A to 5E illustrate initialization and synchronization methods between multiple processes when a process operates abnormally during execution of a secure mode according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to exemplary embodiments of the present invention, a secure data processing device receives digital content (hereinafter referred to as ‘secure content’), which is protected by content protection technology such as Digital Rights Management (DRM), and executes the received secure content using a secure Operating System (OS) which is different from the main OS and external access to which is blocked. According to exemplary embodiments of the present invention, the secure content may be, for example, encrypted audio stream and/or video stream which are protected by the content protection technology such as DRM. In addition, the secure data processing device, which is a device capable of receiving and executing secure content, such as a Television (TV), a Personal Computer (PC) and a mobile terminal, may include any device as long as such a device can execute secure content using a secure OS which is different from the main OS and to which external access is blocked.

Exemplary embodiments of the present invention will be described on the assumption that the secure data processing device is applied to a mobile device such as a smart phone.

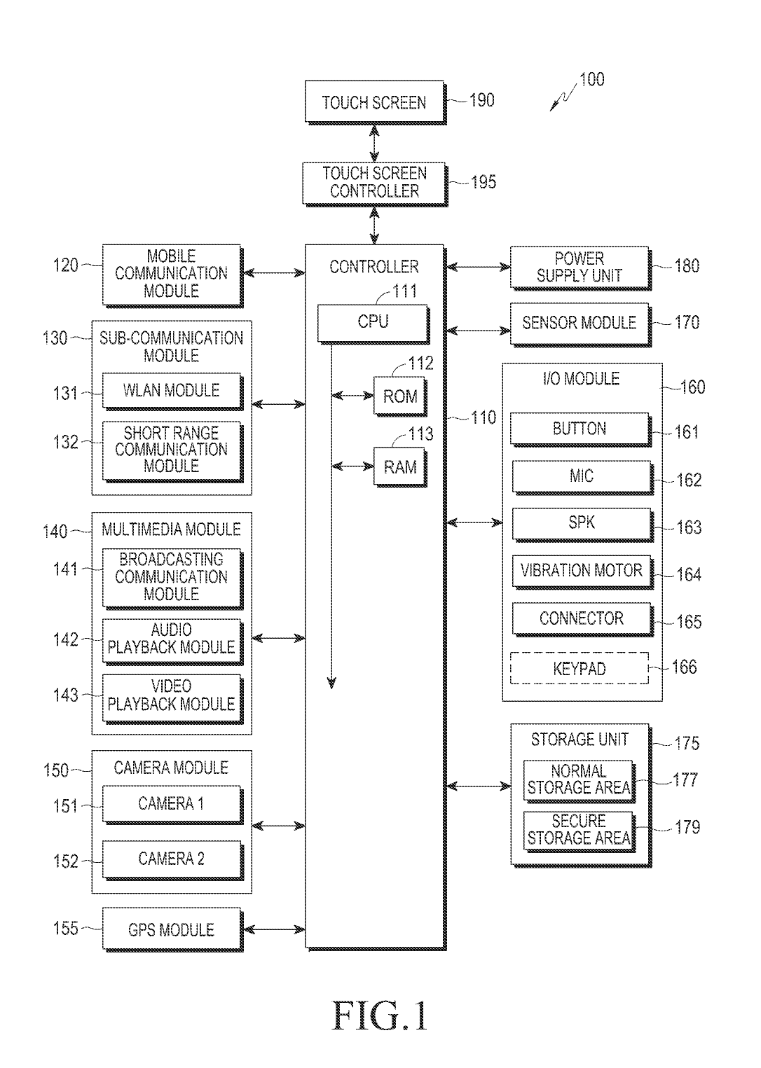

FIG. 1 is a schematic block diagram illustrating a mobile device, to which exemplary embodiments of the present invention are applicable.

Referring to FIG. 1, a device 100 may be connected to an external device (not shown) using a mobile communication module 120, a sub-communication module 130 and/or a connector 165. The term ‘external device’ may be construed to include other devices (not shown), cellular phones (not shown), smart phones (not shown), tablet PCs (not shown), and (not shown), and the like.

The device 100 includes a touch screen 190 and a touch screen controller 195. The device 100 further includes a controller 110, the mobile communication module 120, the sub-communication module 130, a multimedia module 140, a camera module 150, a Global Positioning System (GPS) module 155, an Input/Output (I/O) module 160, a sensor module 170, a storage unit 175, and a power supply unit 180. The sub-communication module 130 includes at least one of a Wireless Local Area Network (WLAN) module 131 and a short-range communication module 132. The multimedia module 140 includes at least one of a broadcast communication module 141, an audio playback module 142 and a video playback module 143. The camera module 150 includes at least one of a first camera 151 and a second camera 152. The I/O module 160 includes at least one of buttons 161, a Microphone (MIC) 162, a Speaker (SPK) 163, a vibration motor 164, the connector 165 and a keypad 166.

The controller 110 may be comprised of a Central Processing Unit (CPU) 111, a Read Only Memory (ROM) 112, in which control programs for control of the device 100 are stored, and a Random Access Memory (RAM) 113, which records signals and/or data received from the outside of the device 100, or which is used as a storage for operations executed in the device 100. The CPU 111 may include a plurality of core processors. For example, the CPU 111 may include a single-core CPU, a dual-core CPU, a triple-core CPU, a quad-core CPU, and the like. The CPU 111, the ROM 112 and the RAM 113 may be interconnected via an internal bus.

The controller 110 may control the mobile communication module 120, the sub-communication module 130, the multimedia module 140, the camera module 150, the GPS module 155, the I/O module 160, the sensor module 170, the storage unit 175, the power supply unit 180, the touch screen 190, and the touch screen controller 195.

The controller 110 performs normal executions and secure executions using the single-processor CPU 111 in two separated modes, namely a main mode and a secure mode, respectively. The secure mode is a mode for performing important executions that require the security, while the normal mode is a mode for performing non-secure executions that do not require the security. According to exemplary embodiments of the present invention, the controller 110 includes a main unit for performing non-secure executions (hereinafter referred to as ‘normal executions’), and a secure unit for performing secure executions, and may perform the normal mode and the secure mode by means of the main unit and the secure unit, respectively. A main OS is executed in the main unit, and a secure OS is separately executed in the secure unit. A memory area used by the secure OS is a secure storage area. Access, by the main OS, to the memory area used by the secure OS (e.g., the secure storage area) is blocked. Accordingly, even if the main OS is an open OS, malicious codes may not access the secure OS and the memory area used by the secure OS.

The controller 110 executes normal programs or applications, or normal content that does not require the security, in the normal mode, and executes programs or applications requiring the security, or secure content requiring the security, in the secure mode. The term ‘programs, applications or content requiring the security’ as used herein may refer to content that requires a high level of security, such as, for example, DRM-set content, banking services, E-commerce, and the like. In addition, the controller 110 may separate all content requiring the security into content requiring high-level security and content requiring low-level security, and process the content requiring high-level security by means of a secure unit 300 and the content requiring low-level security by means of a main unit 200. Particularly, according to exemplary embodiments of the present invention, the controller 110 processes the secure content, which is protected by the content protection technology such as DRM, in the secure mode. For example, the controller 110 may perform decryption, decoding, and rendering on audio and/or video streams corresponding to secure content in the secure mode under control of the secure OS.

More specifically, upon receiving a content execution request from a user, the controller 110 reads audio and/or video streams corresponding to content in the normal mode, and determines whether the read audio and/or video streams are audio and/or video streams requiring the security. If the read audio and/or video streams are audio and/or video streams requiring the security, the controller 110 switches to the secure mode and processes the read audio and/or video streams requiring the security. For example, the controller 110 performs decryption, decoding, and rendering on the audio and/or video streams requiring the security in the secure mode, and stores the processing results in the secure storage area, access to which is restricted. The controller 110 outputs the audio and/or video data stored in the secure storage area through the multimedia module 140 in the secure mode. In this way, the controller 110 processes secure content using a secure storage area 179, access to which is restricted, in the secure mode, thereby making hacking of the secure content difficult.

When processing the audio and/or video streams requiring the security, the controller 110 may perform only decryption on the audio stream in the secure mode, and perform decoding and rendering on the decrypted audio stream in the normal mode.

When performing decoding and rendering on the decrypted audio stream in the normal mode, the controller 110 decodes the decrypted audio stream and then stores the decoded audio data in a normal storage area 177. The normal storage area 177 is a non-secure storage area, which is accessible in the normal mode regardless of the rights, and if audio data is stored in the normal storage area 177, the audio data may be hacked. In some cases, by exploiting these shortcomings, a malicious user may attempt to configure an audio stream (hereinafter referred to as a ‘tempered audio stream’) with a different type of data (for example, video data) other than audio data, using an identifier indicating audio data, and thus attempt to use the audio stream illegally. In other words, in the case in which video data is configured as a tempered audio stream, even if the tempered audio stream is decrypted in the secure mode, the video data may be calculated and stored in the normal storage area if the decrypted tempered audio stream is decoded in the normal mode, such the malicious user may attempt to hack his desired video data by creating a tempered audio stream.

Like the audio data of the audio stream which is tempered by the video data to configure the tempered audio stream as explained above, a first encrypted data of a different type other than the audio data may be tempered as a second encrypted data.

In order to prevent such hacking or malicious behavior, according to exemplary embodiments of the present invention, the controller 110 detects a second encrypted data by determining whether a first encrypted data required to be processed in a first secure mode is a second encrypted data requiring a second secure mode, and performs secure decryption only if the first encrypted data is not a second encrypted data.

For example, the controller 110 detects a tempered audio stream by determining whether a read audio stream is a tempered audio stream, in the secure mode to process an audio stream, and performs secure decryption only if the read audio stream is not a tempered audio stream. By doing so, the controller 110 may prevent a malicious user from hacking video data using a tempered audio data.

The mobile communication module 120, under control of the controller 110, allows the device 100 to be connected to an external device by mobile communication using at least one or multiple antennas (not shown). The mobile communication module 120 exchange wireless signals for voice calls, video calls, Short Message Service (SMS) messages, Multimedia Messaging Service (MMS) message, and the like with cellular phones (not shown), smart phones (not shown), tablet PCs (not shown), or other devices (not shown) having their own phone numbers which are entered and stored in the device 100.

The sub-communication module 130 may include at least one of the WLAN module 131 and the short-range communication module 132. For example, the sub-communication module 130 may include any one or both of the WLAN module 131 and the short-range communication module 132.

The WLAN module 131, under control of the controller 110, may be connected to the Internet in the place where a wireless Access Point (AP, not shown) is installed. The WLAN module 131 supports the Institute of Electrical and Electronics Engineers (IEEE) WLAN standard IEEE802.11x. The short-range communication module 132, under control of the controller 110, may wirelessly perform short-rage communication between the device 100 and an image forming device (not shown). The short-range communication method may include Bluetooth, Infrared Data Association (IrDA), and the like.

The device 100 may include at least one of the mobile communication module 120, the WLAN module 131 and the short-range communication module 132 depending on its performance. For example, the device 100 may include a combination of the mobile communication module 120, the WLAN module 131, and the short-range communication module 132 depending on its performance.

At least one of the mobile communication module 120, the WLAN module 131 and the short-range communication module 132 may, under control of the controller 110, send a request signal for requesting secure content to an external content provider, or receive secure content from the external content provider in response to the secure content request. At least one of the mobile communication module 120, the WLAN module 131 and the short-range communication module 132 may, under control of the controller 110, request and receive key data and authentication information for decrypting or authenticating the content protected by DRM.

The multimedia module 140 may include the broadcast communication module 141, the audio playback module 142 and/or the video playback module 143. The broadcast communication module 141, under control of the controller 110, may receive broadcast signals (for example, TV broadcast signals, radio broadcast signals, data broadcast signals, and the like) and additional broadcast information (for example, Electric Program Guide (EPG), Electric Service Guide (ESG), and the like), which are transmitted from the broadcasting stations, via a broadcast antenna (not shown). The audio playback module 142, under control of the controller 110, may play digital audio files (with a file extension of, for example, mp3, wma, ogg, way, and the like), which are stored or received. The video playback module 143, under control of the controller 110, may play digital video files (with a file extension of, for example, mpeg, mpg, mp4, avi, mov, mkv, and the like), which are stored or received. The video playback module 143 may play digital audio files as well.

The multimedia module 140 may include the audio playback module 142 and the video playback module 143, excluding the broadcast communication module 141. The audio playback module 142 or the video playback module 143 in the multimedia module 140 may be included in the controller 110. The multimedia module 140, under control of the controller 110, may process audio and/or video data stored in the normal storage area 177 in the normal mode, and process audio and/or video data stored in the secure storage area 179 in the secure mode.

The camera module 150 may include at least one of the first and second cameras 151 and 152, which can capture still images or moving images under control of the controller 110. The first camera 151 or the second camera 152 may include a secondary light source (for example, a flash) for providing the light needed for image capturing. The first camera 151 may be disposed on the front of the device 100, while the second camera 152 may be disposed at the rear of the device 100. As another example, the first and second cameras 151 and 152 may be disposed adjacent to each other (with a gap there between set to be greater than 1 cm and less than 8 cm), making it possible to capture 3-Dimensional (3D) still images or 3D moving images.

The GPS module 155 may receive radio waves from a plurality of GPS satellites (not shown) in the Earth orbit, and calculate the location of the device 100 using the Time of Arrival (ToA) from the GPS satellites to the device 100.

The I/O module 160 may include at least one of the plurality of buttons 161, the microphone 162, the speaker 163, the vibration motor 164, the connector 165, and the keypad 166.

The buttons 161 may be formed on the front, side and/or rear of the housing of the device 100, and may include at least one of a power/lock button (not shown), a volume button (not shown), a menu button, a home button, a back button, and a search button.

The microphone 162 generates electrical signals by receiving voice and/or sound, under control of the controller 110.

The speaker 163, under control of the controller 110, may output, to the outside of the device 100, the sounds corresponding to a variety of signals (for example, wireless signals, broadcast signals, digital audio files, digital video files and/or photo-shooting signals) from the mobile communication module 120, the sub-communication module 130, the multimedia module 140 and/or the camera module 150. The speaker 163 may output the sounds (for example, button input sounds for calls, ring-back tones and the like) corresponding to the functions performed by the device 100. One or multiple speakers 163 may be formed in appropriate position(s) of the housing of the device 100.

The vibration motor 164 may convert electrical signals into mechanical vibrations under control of the controller 110. For example, if the device 100 in the vibration mode receives a voice call from another device (not shown), the vibration motor 164 operates. One or multiple vibration motors 164 may be formed in the housing of the device 100. The one or multiple vibration motors 164 may operate in response to a user's touch action taking place on the touch screen 190, and a continuous movement (or a drag) of a touch on the touch screen 190.

The connector 165 may be used as an interface for connecting the device 100 to the external devices (not shown) or the power source (not shown). The connector 165 may transmit the data stored in the storage unit 175 of the device 100 to the external devices (not shown) or may receive the data from the external devices (not shown), via a wired cable that is connected to the connector 165 under control of the controller 110. The device 100 may receive power from the power source (not shown) or charge its rechargeable battery (not shown) via the wired cable connected to the connector 165.

The keypad 166 may receive key inputs from the user, for control of the device 100. The keypad 166 includes a physical keypad (not shown) formed on the housing of the device 100, or a virtual keypad (not shown) displayed on the touch screen 190. The physical keypad formed on the housing of the device 100 is optional depending on the performance or structure of the device 100.

The sensor module 170 includes at least one sensor for detecting the status of the device 100. For example, the sensor module 170 may include a proximity sensor (not shown) for detecting whether the user is close to the device 100, an illuminance sensor (not shown) for detecting the amount of light in the vicinity of the device 100, and/or a motion sensor (not shown) for detecting the motion (for example, rotation, acceleration, and vibration) of the device 100. At least one sensor may detect the status, generate a signal corresponding to the detection, and transfer the generated signal to the controller 110. Sensors may be added or removed to/from the sensor module 170 depending on the performance of the device 100.

The storage unit 175, under control of the controller 110, may store the signals and/or data which are input and output according to the operation of the mobile communication module 120, the sub-communication module 130, the multimedia module 140, the camera module 150, the GPS module 155, the I/O module 160, the sensor module 170 and the touch screen 190. The storage unit 175 may store control programs and applications for control of the device 100 and/or the controller 110.

The term ‘storage unit’ may be construed to include the storage unit 175, the ROM 112 and RAM 113 in the controller 110, or a memory card (not shown; for example, a Secure Digital (SD) card and a memory stick), which is mounted in the device 100. The storage unit may include a non-volatile memory, a volatile memory, a Hard Disk Drive (HDD), or a Solid State Drive (SSD). The storage unit may include a non-transitory computer-readable storage medium.

The storage unit 175 may include the normal storage area 177 and the secure storage area 179. The normal storage area 177 may store normal data and programs, whereas the secure storage area 179 may store data and programs that only the components may access, which are allowed to be accessed in the secure mode. According to exemplary embodiments of the present invention, the normal storage area 177 may store audio and/or video streams corresponding to the content that is downloaded using at least one of the mobile communication module 120, the WLAN module 131 and the short-range communication module 132. Also, the normal storage area 177 may store the decrypted audio and/or video data and the decoded audio and/or video data, which are generated when the device 100 performs decryption and decoding on the normal content in the normal mode. The secure storage area 179 may store the decrypted audio and/or video data and the decoded audio and/or video data, which are generated when the device 100 performs decryption and decoding on the secure content in the secure mode.

The power supply unit 180, under control of the controller 110, may supply power to one or multiple rechargeable batteries (not shown) amounted on the housing of the device 100. One of multiple rechargeable batteries (not shown) may supply power to the device 100. The power supply unit 180 may supply, to the device 100, the power which is received from the external power source (not shown) via the wired cable connected to the connector 165.

The touch screen 190 may provide the user with User Interfaces (UIs) which correspond to a variety of services (for example, voice and/or data communication, data transmission, broadcasting, photography). According to exemplary embodiments of the present invention, the touch screen 190 may provide UIs for execution of applications, such as a content download application and a content playback application.

The touch screen 190 may transfer, to the touch screen controller 195, the analog signals which correspond to at least one touch taking place on the UI. The touch screen 190 may receive at least one touch by the user's body (for example, fingers including the thumb) and/or by a touch input means (for example, a stylus pen). The touch screen 190 may receive a continuous movement of a touch while at least one touch is taking place thereon. The touch screen 190 may transfer, to the touch screen controller 195, the analog signals which correspond to a continuous movement of an input touch. For example, the touch screen 190 may transfer, to the touch screen controller 195, the analog signals which correspond to the user's request for executing a content download application, or to a touch action corresponding to a variety of user's choices which occur during execution of the content download application.

According to exemplary embodiments of the present invention, the touches may not be limited to the touches between the touch screen 190 and the user's body, or between the touch screen 190 and the touch input means, but may also include non-contact touches (which may happen when a detectable gap between the touch screen 190 and the user's body, or between the touch screen 190 and the touch input means is, for example, 1 mm or less). The gap detectable by the touch screen 190 may be subject to change depending on the performance or structure of the device 100.

The touch screen 190 may be implemented using, for example, the resistive type, the capacitive type, the infrared type, or acoustic wave type configurations.

The touch screen controller 195 converts the analog signals received from the touch screen 190 into digital signals (for example, X/Y coordinates), and transfers them to the controller 110. The controller 110 may control the touch screen 190 using the digital signals received from the touch screen controller 195. For example, the controller 110 may select or execute a shortcut icon (not shown) displayed on the touch screen 190 in response to a touch. The touch screen controller 195 may be included in the controller 110.

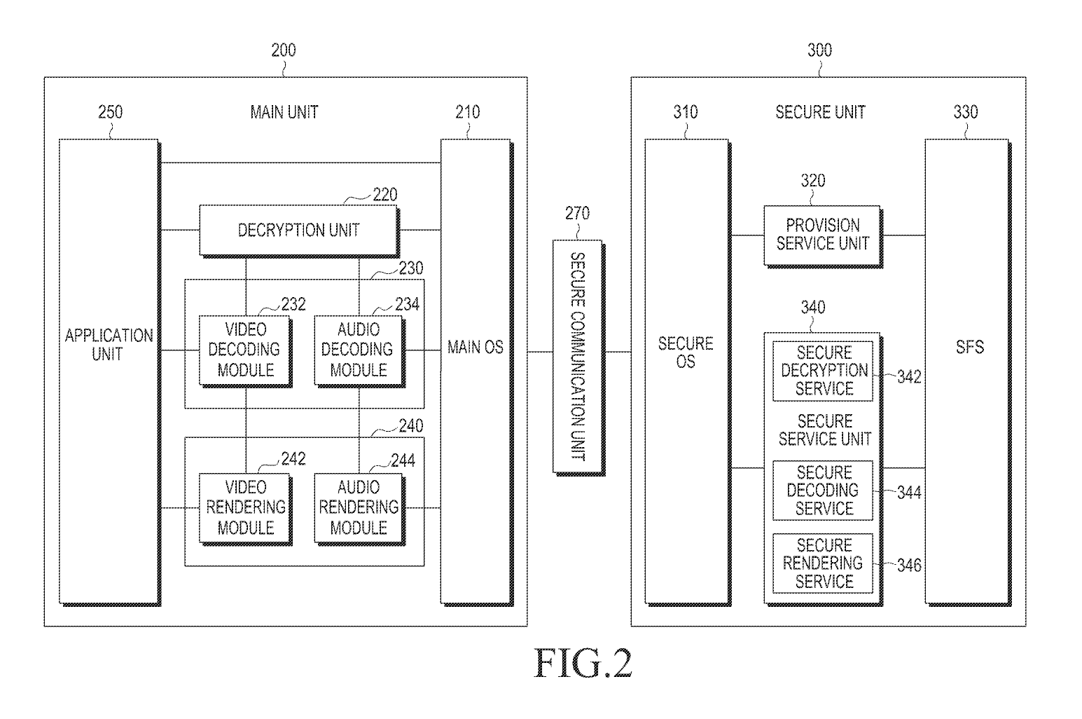

FIG. 2 illustrates a configuration of a CPU in a controller according to an exemplary embodiment of the present invention.

Referring to FIG. 2, the CPU 111 includes a main unit 200 for performing normal executions, a secure unit 300 for performing secure executions, and a secure communication unit 270 responsible for communication between the main unit 200 and the secure unit 300.

The main unit 200 executes normal programs or applications or normal content not requiring the security in the normal mode, and commands or requests the secure unit 300 to perform associated executions, via the secure communication unit 270, if the secure unit 300 is required to execute secure programs or applications or secure content requiring the security.

A main OS 210 is executed in the main unit 200, and a secure OS 310 is separately executed in the secure unit 300. The main OS 210 cannot directly access the secure unit 300, and may command or request execution of specific functions, threads and processes through the secure communication unit 270. The secure communication unit 270 enables the proposed data processing device or a mobile device to switch between the secure mode and the non-secure mode (i.e., the normal mode). The secure communication unit 270 may separate a memory area accessible by the main unit 200 and a memory area accessible by the secure unit 300 in a hardware manner, using a predetermined bit. As a result, access by the main unit 200 may be blocked to the secure storage area 179, which is the memory area used by the secure unit 300. Accordingly, even if the main OS 210 of the main unit 200 is an open OS, malicious codes may not access the secure OS 310 and the secure storage area 179 used by the secure OS 310. A process of processing content requiring the security in the secure unit 300 will be described below by way of example.

Upon receiving a request for decrypting, decoding, or rendering secure content from the main unit 200, the secure unit 300 performs decryption, decoding, or rendering on the secure content in the secure mode.

In particular, upon receiving a secure decryption request for an audio stream, the secure unit 300 determines whether the audio stream is a tempered audio stream, based on the predetermined audio stream criteria, before performing secure decryption. The predetermined audio stream criteria may be the frame size of the audio stream, or the start code included in the audio stream. If a frame size of the audio stream requiring secure decryption is greater than the predetermined reference audio frame size, the secure unit 300 may determine the audio stream as a tempered audio stream. In addition, if a start code included in the audio stream requiring secure decryption is not the start code corresponding to the audio stream, the secure unit 300 may determine the audio stream as a tempered audio stream.

If the secure unit 300 determines the audio stream as a tempered audio stream before performing secure decryption, the secure unit 300 notifies the main unit 200 of its detection of the tempered audio stream, without performing secure decryption on the audio stream.

In contrast, if the secure unit 300 does not determine the audio stream as a tempered audio stream before performing secure decryption, the secure unit 300 performs secure decryption on the audio stream.

After performing secure decryption on the audio stream, the secure unit 300 determines whether the secure-decrypted audio stream is a tempered audio stream. The secure unit 300 may determine that the secure-decrypted audio stream is a tempered audio stream, if it is determined that a codec corresponding to the decrypted audio stream is not an audio codec but a video codec by checking (e.g., analyzing) the codec corresponding to the decrypted audio stream. In contrast, the secure unit 300 may also determine that the decrypted audio stream is a tempered audio stream, if not only the codec but also various information included in the decrypted audio stream are information indicating that the decrypted audio stream is a video stream.

If the decrypted audio stream is determined as a tempered audio stream after performing secure decryption, the secure unit 300 notifies the main unit 200 of its detection of the tempered audio stream, interrupting decoding for the secure-decrypted audio data.

Upon receiving a secure decryption command for a video stream from the main unit 200, the secure unit 300 performs secure decryption on the video stream using a security key and authentication information, and stores the secure-decrypted audio stream in the secure storage area 179.

Configuration of the above-described main unit 200 and secure unit 300 will be described in more detail. The main unit 200 includes the main OS 210, a decryption unit 220, a decoding unit 230, a rendering unit 240, and an application unit 250. The secure unit 300 includes the secure OS 310, a provision service unit 320, a Secure File System (SFS) 330 and a secure service unit 340.

First, the main OS 210, the decryption unit 220, the decoding unit 230, the rendering unit 240 and the application unit 250 in the main unit 200 will be described.

The main OS 210 (e.g., a main OS of the device 100) is responsible for the overall operation of the device 100 in the normal mode. Particularly, the main OS 210 executes normal programs or applications or normal content not requiring the security in the normal mode, and commands or requests the secure unit 300 to perform associated executions, through the secure communication unit 270, if the secure unit 300 is required to execute secure programs or applications or secure content requiring the security.

Upon request for content execution, the decryption unit 220 reads audio and/or video streams corresponding to the requested content from the normal storage area 177, and determines whether the read audio and/or video streams are audio and/or video streams requiring the security. The decryption unit 220 may determine whether the read audio and/or video streams are audio and/or video streams requiring the security, by determining whether the content protection system such as DRM is applied to the audio and/or video streams. In addition, the decryption unit 220 may determine whether the read audio and/or video streams are audio and/or video streams requiring the security, if an identifier used to execute audio and/or video streams in the secure mode is included in the audio and/or video streams.

If the requested content corresponds to audio and/or video streams not requiring the security, the decryption unit 220 stores the audio and/or video streams not requiring the security in the normal storage unit 177 by separating the audio and/or video streams into payload units, and requests decoding thereof. If the requested content corresponds to audio and/or video streams requiring the security, the decryption unit 220 separates the audio and/or video streams requiring the security into payload units, and requests the main OS 210 to perform secure decryption on the audio and/or video streams which are separated into payload units and require the security. Upon receiving information indicating the completion of secure decryption from the main OS 210, the decryption unit 220 requests the decoding unit 230 to perform decoding.

The decoding unit 230 includes a video decoding module 232 and an audio decoding module 234. Upon request for decoding normal audio and/or video streams not requiring the security, the decoding unit 230 decodes the audio and/or video streams which are stored in the normal storage area 177 in units of payloads, into audio and/or video data on a frame basis in the normal mode using the audio and/or video codecs by means of the video decoding module 232 and/or the audio decoding module 234. The decoding unit 230 stores the decoded audio and/or video data in the normal storage area 177 and requests the rendering unit 240 to perform rendering. In contrast, upon request for decoding a video stream requiring the security, the decoding unit 230 requests the main OS 210 to perform secure decoding in the secure mode. Thereafter, upon receiving information indicating the completion of secure decoding from the main OS 210, the decoding unit 230 requests the rendering unit 240 to perform rendering.

The rendering unit 240 includes a video rendering module 242 and an audio rendering module 244. Upon request for rendering normal audio and/video data not requiring the security, the rendering unit 240 performs video rendering on the decoded video data stored in the normal storage area 177 to generate 2-Dimensional (2D) or 3D video signals that can be displayed on the touch screen 190, in the normal mode by means of the video rendering module 242 and/or the audio rendering module 244, and performs rendering on the decoded audio data to generate analog audio signals.

In contrast, upon request for rendering video data requiring the security, the rendering unit 240 requests the main OS 210 to perform secure rendering in the secure mode. Thereafter, upon receiving information indicating the completion of secure rendering from the main OS 210, the rendering unit 240 requests outputting of the rendered video and audio signals. The rendered video and audio signals may be output through a display device and a speaker, respectively.

The application unit 250 includes applications such as a content download application and a content playback application, and performs an associated function if the application unit 250 executes an application at the user's request.

Next, the secure OS 310, the provision service unit 320, the SFS 330 and the secure service unit 340 in the secure unit 300 will be described.

The secure OS 310 (e.g., a secure OS of the device 100) executes secure content requiring the security in the secure mode. In particular, upon receiving at least one of a decryption request, a decoding request, and a rendering request for a video stream requiring the security and a decryption request for an audio stream requiring the security, from the main OS 210 through the secure communication unit 270, the secure OS 310 forwards the corresponding at least one of a decryption request, a decoding request and a rendering request to the secure service unit 340.

The provision service unit 320 receives a security key and authentication information from the external content protection service provider(s) such as a DRM service provider, and records the security key and authentication information in the SFS 330. The security key and authentication information may be stored in the SFS 330 in advance by the device manufacturers.

The SFS 330 corresponds to a storage area accessible in the secure unit 300. The SFS 330 includes a variety of programs and information for executions of secure content requiring the security, for example, decryption execution, decoding execution, and rendering execution for audio and/or video signals. In addition, the SFS 330 stores the security key and authentication information recorded by the provision service unit 320.

The secure service unit 340 provides a secure decryption service 342 for performing secure decryption, a secure decoding service 344 for performing secure decoding, and a secure rendering service 346 for performing secure rendering. The secure service unit 340 performs secure decryption using the secure decryption service 342. The secure service unit 340 performs secure decoding using the secure decoding service 344. The secure service unit 340 performs secure rendering using the secure rendering service 346.

Upon receiving a decryption request for a video stream requiring the security from the secure OS 310, the secure service unit 340 performs secure decryption on the video stream requiring the security using the security key and authentication information stored in the SFS 330, and stores the secure-decrypted video stream in the secure storage area 179. Upon receiving a decoding request for a video stream requiring the security from the secure OS 310, the secure service unit 340 performs secure decoding on the video stream requiring the security using a related video codec, and stores the secure-decoded video stream in the secure storage area 179. Upon receiving a rendering request for video data requiring the security from the secure OS 310, the secure service unit 340 performs secure rendering on the decoded video data to create video signals for displaying it on a 2D or 3D screen, and outputs the video signals.

In contrast, upon receiving a decryption request for a video stream requiring the security from the secure OS 310, the secure service unit 340 may perform secure decryption on an associated audio stream requiring the security using the security key and authentication information stored in the SFS 330, and store the secure-decrypted audio stream in the normal storage area 177.

As described above, the secure service unit 340 stores the decryption, decoding and rendering results on a video stream requiring the security, in the secure storage area 179, enhancing the security for video streams and thus making hacking of the video streams difficult.

However, for a video stream requiring the security, the secure service unit 340 stores its associated decrypted audio stream in the normal storage area 177. Consequently, there may be a risk of hacking. In other words, if a malicious user configures a tempered audio stream with a different type of data (for example, video data) other than audio data by using an identifier indicating audio data, the tempered audio stream may be decrypted in the secure mode and stored in the opened normal storage area 177, which is vulnerable to hacking.

In order to prevent such a vulnerability to hacking, when performing decryption on an audio stream received from the secure OS 310 and requiring the security, the secure service unit 340 determines whether the received audio stream is a tempered audio stream, to detect the tempered audio stream. Before performing decryption on an audio stream, the secure service unit 340 may determine whether the audio stream is a tempered audio stream, and interrupt the decryption if the audio stream is a tempered audio stream. In contrast, after performing decryption on an audio stream, the secure service unit 330 may determine whether the audio stream is a tempered audio stream, and provide no decryption results if the audio stream is a tempered audio stream.

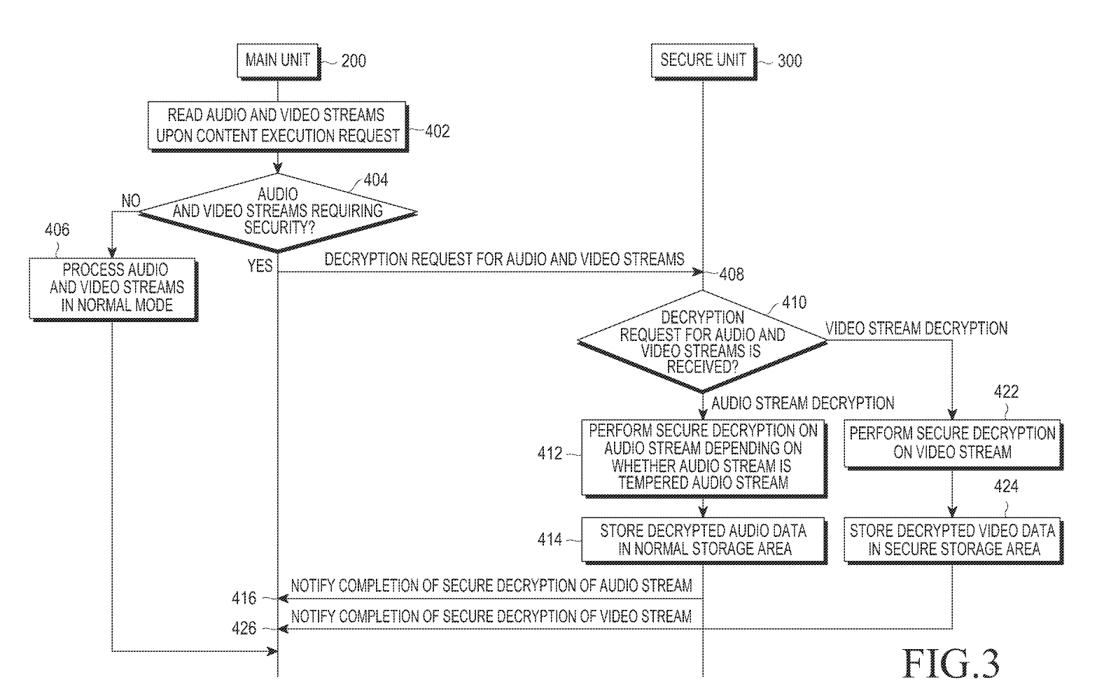

FIG. 3 is a flowchart illustrating operations of a main unit and a secure unit upon a content execution request according to an exemplary embodiment of the present invention.

Referring to FIG. 3, upon a content execution request by the user, the main unit 200 reads audio and video streams corresponding to the content from the normal storage area 177 in step 402. The user may enter the content execution request by executing a content playback application in the device 100 and touching (e.g., selecting) his/her desired content in the content playback application displayed on the touch screen 190.

In step 404, the main unit 200 determines whether the read audio and video streams correspond to content requiring the security. The main unit 200 may determine whether the read audio and video streams are audio and video streams requiring the security, by allowing its decryption unit 220 to determine whether the read audio and video streams are audio and video streams, to which the content protection system such as DRM is applied. In addition, the decryption unit 220 included in the main unit 200 may determine whether the read audio and video streams are audio and video streams requiring the security, if an identifier used to execute audio and video streams in the secure mode is included in the audio and video streams.

If the audio and video streams do not correspond to content requiring the security, the main unit 200 processes the audio and video streams in the normal mode in step 406. For example, the main unit 200 performs decoding on the audio and video streams in the normal mode, and stores the decoded audio and video data in the normal storage area 177. The main unit 200 renders and outputs the decoded audio and video data.

In contrast, if the audio and video streams correspond to the content requiring the security in step 404, the main unit 200 requests decryption of the audio and video streams from the secure unit 300 in step 408.

In step 410, the secure unit 300 determines whether the decryption request for the audio and video streams has been received. If the secure unit 300 determines that a request for a decryption of an audio stream is received in step 410, the secure unit 300 proceeds to step 412 for decryption of an audio stream. In contrast, if the secure unit 300 determines that a request for a decryption of a video stream is received in step 410, the secure unit 300 proceeds to step 422 for decryption of a video stream.

In step 412, the secure unit 300 performs secure decryption on the audio stream depending on the results of determining whether the audio stream is a tempered audio stream. In step 414, the secure unit 300 stores the secure-decrypted audio data in the normal storage area 177. In step 416, the secure unit 300 delivers, to the main unit 200, information indicating the completion of secure decryption of the audio stream.

In contrast, the secure unit 300 performs secure decryption on the video stream in step 422, and stores the secure-decrypted video data in the secure storage area 179 in step 424. In step 426, the secure unit 300 delivers, to the main unit 200, information indicating the completion of secure decryption of the video stream.

As described above, according to exemplary embodiments of the present invention, when performing secure decryption on an audio stream, the secure unit 300 performs secure decryption on the audio stream depending on the results of determining whether the audio stream is a tempered audio stream, making it possible to prevent the decrypted video data generated by decrypting the tempered audio stream from being stored in the normal storage area 177.

The above-described process of performing secure decryption on an audio stream by the secure unit 300 will be described in more detail below.

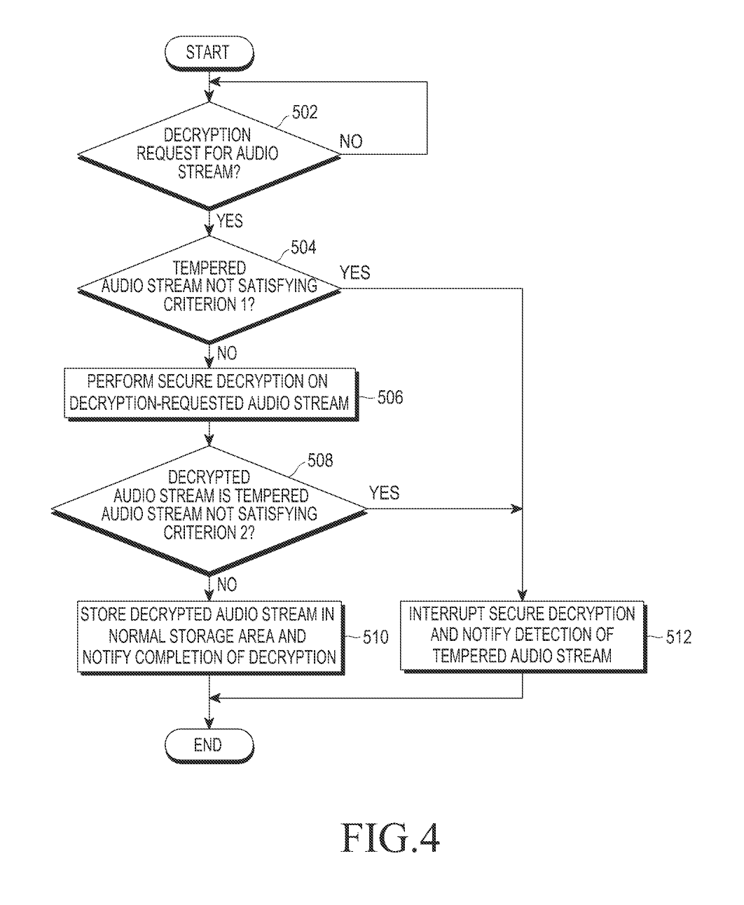

FIG. 4 is a flowchart illustrating a process of performing secure decryption on an audio stream by a secure unit according to an exemplary embodiment of the present invention.

Referring to FIG. 4, the secure service unit 340 of the secure unit 300 may receive a decryption request for an audio stream by the main OS 210, from the secure OS 310. In step 502, the secure service unit 340 determines whether a decryption request for an audio stream is received. If the secure service unit 340 determines that a decryption request for an audio stream has not received, the secure service unite 340 continues to poll for a decryption request for an audio stream. In contrast, upon receiving the decryption request for an audio stream in step 502, the secure service unit 340 proceeds to step 504.

In step 504, the secure service unit 340 determines whether the decryption-requested audio stream is a tempered audio stream that does not satisfy a predetermined first criterion. For example, the predetermined first criterion may be a frame size of an audio stream or a start code of an audio stream. If the decryption-requested audio stream is greater that a predetermined audio frame size, the secure service unit 340 may determine that the decryption-requested audio stream is a tempered audio stream. In addition, if the start code of the decryption-requested audio stream is not a start code indicating an audio stream, the secure service unit 340 may determine that the decryption-requested audio stream is a tempered audio stream.

If the decryption-requested audio stream is an audio stream satisfying the predetermined first criterion, the secure service unit 340 proceeds to step 506 in which the secure service unit 340 performs secure decryption on the decryption-requested audio stream.

In step 508, the secure service unit 340 determines whether the secure-decrypted audio stream is a tempered audio stream that does not satisfy a predetermined second criterion. For example, the predetermined second criterion may be codec information. The secure service unit 340 may determine that the audio stream is a tempered audio stream, if codec information included in the decrypted audio stream is not audio codec information corresponding to the predetermined second criterion, for example, is codec information corresponding to a video stream.

If the secure service unit 340 determines that the secure-decrypted audio stream is an audio stream satisfying the predetermined second criterion in step 508, the secure service unit 340 proceeds to step 510 in which the secure service unit 340 stores the secure-decrypted audio stream in the normal storage area 177 and notifies the secure OS 310 of its completion of secure decryption of the audio stream.

In contrast, if the secure service unit 340 determines that the audio stream is a tempered audio stream not satisfying the predetermined first criterion or a tempered audio stream not satisfying the predetermined second criterion in step 508, the secure service unit 340 proceeds to step 512 in which the secure service unit 340 interrupts the decryption and notifies the secure OS 310 that decryption-requested audio stream is a tempered audio stream.

Accordingly, the secure OS 310 may notify the main OS 210 that the decryption-requested audio stream is a tempered audio stream, and the main OS 210 may interrupt the playback or consumption of the tempered audio stream.

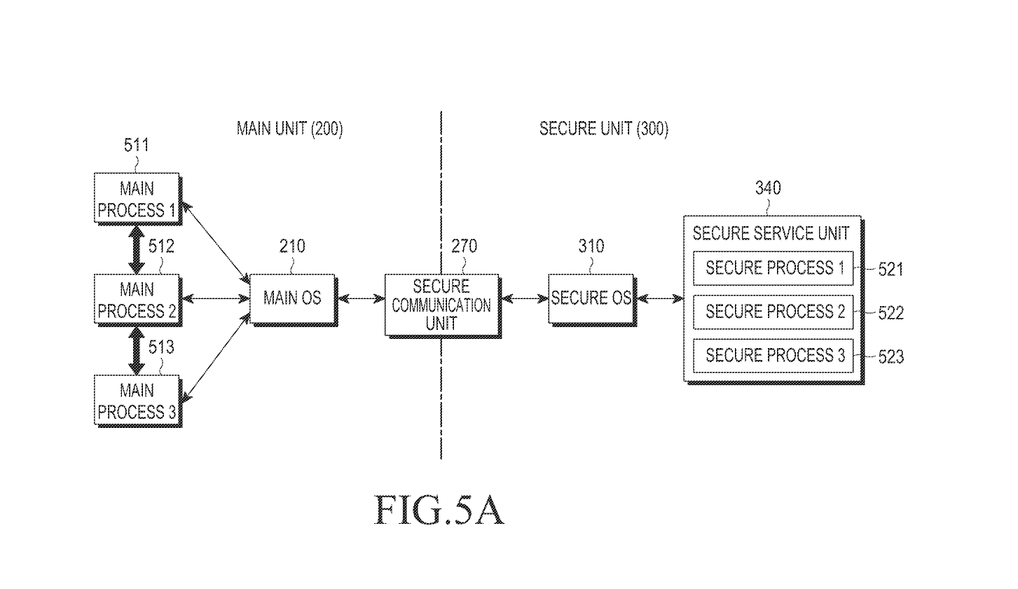

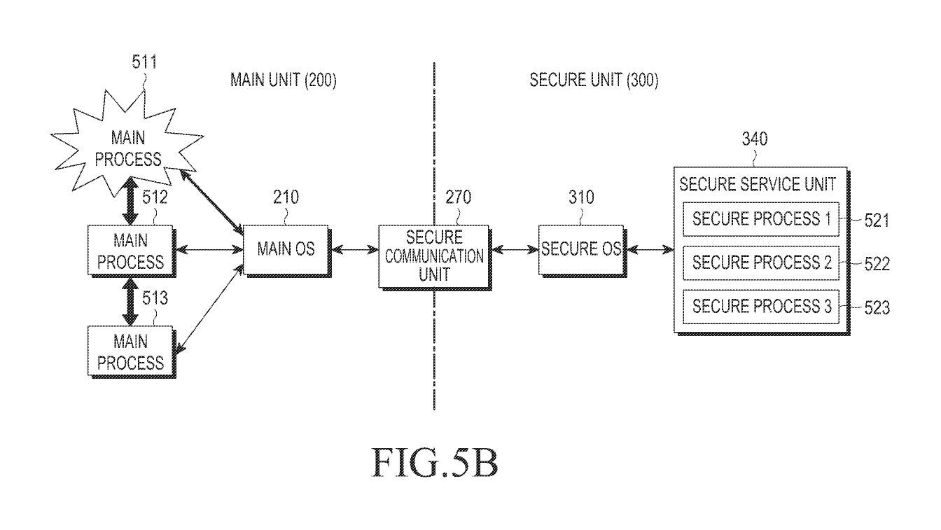

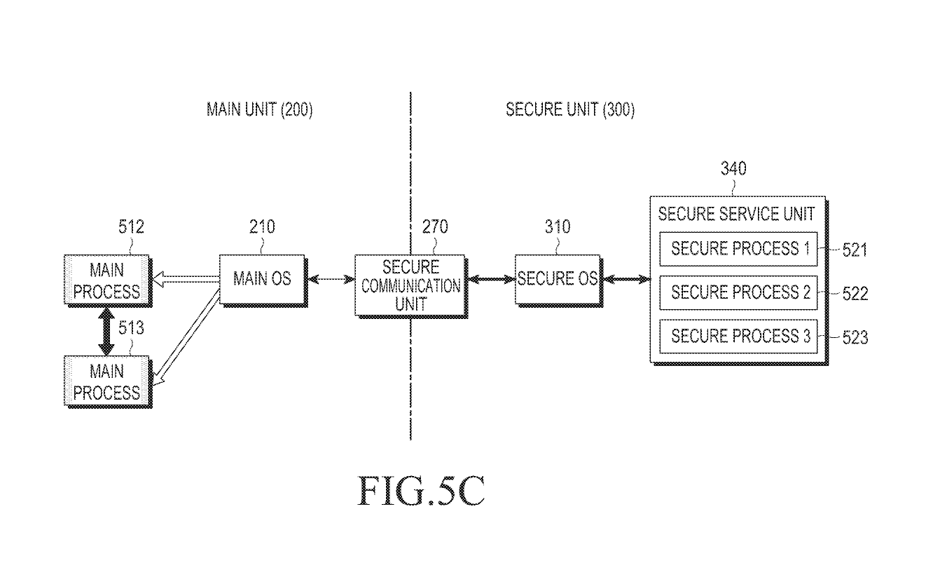

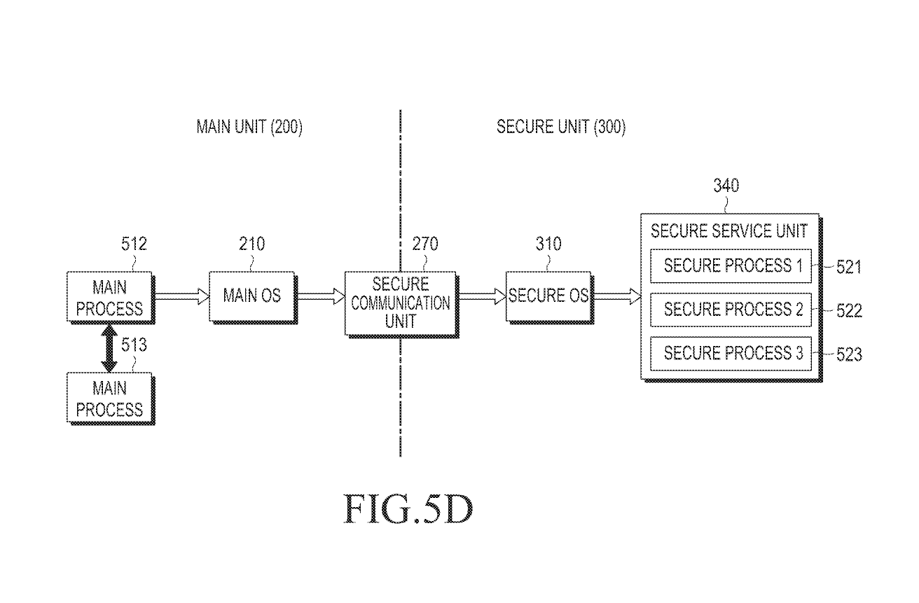

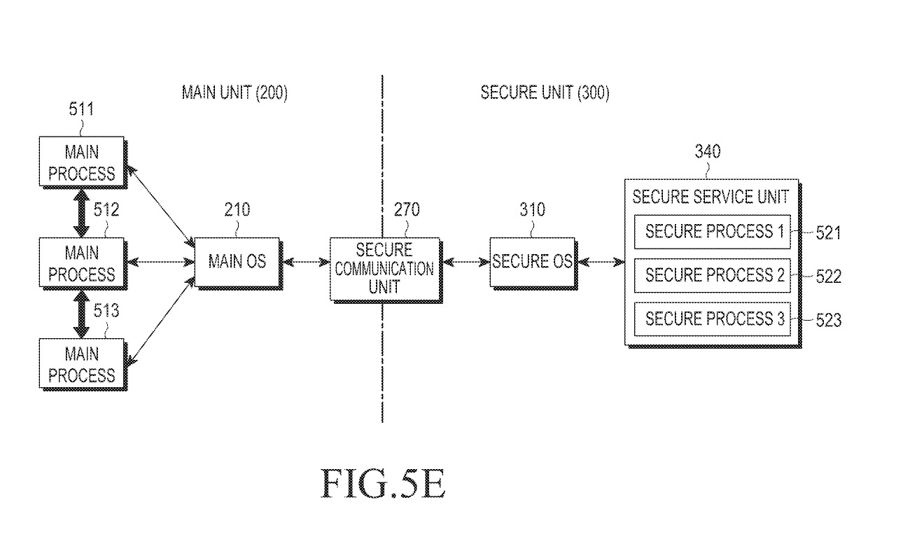

FIGS. 5A to 5E illustrate initialization and synchronization methods between multiple processes when a process operates abnormally during execution of a secure mode according to an exemplary embodiment of the present invention.

Referring FIGS. 5A to 5E, for example, if the user desires to execute content related to DRM according to an exemplary embodiment of the present invention, multiple main processes 511, 512 and 513 are executed in the main unit 200 including a main OS 210 and a secure communication unit 270 for communicating with the secure unit 300 including a secure OS 310 and a secure service unit 340. At least one secure process corresponding to the multiple main processes 511, 512 and 513 is executed in the secure service unit 340 of the secure unit 300. For example, first to third secure processes 521, 522 and 523 corresponding to the multiple main processes 511, 512 and 513 may be executed in the secure service unit 340. The first to third main processes 511, 512 and 513 are processes that operate in association with each other to execute one application. For example, if the application is for receiving content such as the latest DRM-set movies, from the remote content provider, and executing the received content, each of the first to third main processes 511, 512 and 513 may be at least one of a decryption process executed by the decryption unit 220, a decoding process executed by the decoding unit 230, a rendering process executed by the rendering unit 240, and a UI process for providing content to the user. Therefore, if any one of the first to third main processes 511, 512 and 513 operates abnormally, the user may not normally watch his/her desired movie. The first to third secure processes 521, 522 and 523 correspond to the first to third main processes 511, 512 and 513, respectively. It will be assumed herein that the first main process 511 is a decryption process, the second main process 512 is a decoding process, and the third main process 513 is a rendering process.

Referring to FIG. 5B, in some cases, while the multiple main processes 511, 512 and 513 are operating in the main unit 200, at least one main process may operate abnormally such as generating no response or stopping its operation, due to an unexpected event. For example, in the example of FIG. 5B, the first main process 511 operates abnormally by being crashed. Even though the first main process 511 operates abnormally in this way, the first secure process 521 corresponding to the first main process 511 still occupies the system resources. In addition, the second and third main processes 512 and 513 associated with the first main process 511, and their corresponding second and third secure processes 522 and 523 also still occupy the system resources. However, even though the first main process 511 operates abnormally in this way (e.g., even though the decryption process for received frames or payloads is not normally performed), a plurality of related processes may occupy the system resources undesirably.

Referring to FIGS. 5B and 5C, the main OS 210 detects the abnormal operation of the first main process 511, and notifies the second and third main processes 511 and 512 of the abnormal operation of the first main process 511. In FIG. 5C, the second and third main processes 512 and 513 are shown darker than those in FIG. 5B, in order to indicate that the second and third main processes 512 and 513 also operate abnormally because the first main process 511 is crashed.

Referring to FIG. 5D, upon receiving from the main OS 210 the notification that the associated first main process 511 is crashed, the second and third main processes 512 and 513 interrupt and initialize their ongoing operations. Thereafter, any one of the second and third main processes 512 and 513 requests the main OS 210 to initialize the first to third secure processes 521, 522 and 523, which are operating in the secure unit 300. In the example of FIG. 5D, the second main process 512 requests the main OS 210 to interrupt and initialize the first to third secure processes 521, 522 and 523, which are operating in the secure unit 300. In response, the main OS 210 may request the secure service unit 340 via the secure communication unit 270 to interrupt and initialize the first to third secure processes 521, 522 and 523, and the secure service unit 340 may interrupt and initialize the first to third secure processes 521, 522 and 523 in response to the request.

Through this process, the first to third secure processes 521, 522 and 523 corresponding to the first to third main processes 511, 512 and 513 may be initialized and synchronized, as shown in FIG. 5E. Therefore, even though at least one of a plurality of associated processes operates abnormally in the system operating both the main OS 210 and the secure OS 310, all of the abnormally operating process and its associated other processes may be initialized and their operations may be synchronized, thereby preventing the system resources from being wasted unnecessarily. In addition, the user may normally receive again DRM content, even though some processes operate abnormally while the user is receiving the DRM content.

As is apparent from the foregoing description, according to exemplary embodiments of the present invention, a secure OS, which is different from the main OS, may be operated on a single System-on-Chip (SoC) to protect important content from the attacks of malicious codes in a chip level, enabling reliable data processing.

In addition, as a secure OS, which is different from the main OS, is operated on a single SoC, the device does not need to have a separate chip in addition to the CPU, for secure data processing, preventing the increase in the manufacturing costs of mobile devices due to the installation of the separate security chip, and eliminating the need to make any change to the manufacturing line of mobile devices.

Furthermore, even if at least one process operates abnormally while a plurality of OSs are operating a plurality of processes, the normal operation of the system may be guaranteed and the system resources may be efficiently used.

Although a mobile device has been considered as the secure data processing device according to exemplary embodiments of the present invention, it will be apparent to those of ordinary skill in the art that the exemplary embodiments of the present invention may be applied to any devices that use an OS, such as digital TVs, set-top boxes, PCs, laptop computers, tablet computers, digital audio players, and the like. In addition, the method according to exemplary embodiments of the present invention may be implemented in the form of program commands that can be executed by means of a variety of computer means, and the program commends may be recorded in computer-readable recording media. The computer-readable recording media may include program commands, data files, data structures and the like, independently or in combination. The program commands recorded in the media may be the commands which are specially designed and configured for the present invention, or the commands which are known to those of ordinary skill in the field of computer software.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A secure data processing device comprising:
a main Operating System (OS);
a plurality of main processes which are executed under control of the main OS and which are associated with each other;
a secure OS which is simultaneously operated with the main OS; and
at least one secure process which is executed under control of the secure OS and which corresponds to at least one of the plurality of main processes,
wherein, if at least one of the plurality of main processes is in an abnormal operation state, an operation of the least one secure process is interrupted and initialized according to a request of the main OS.

2. The secure data processing device of claim 1, wherein the secure OS processes data requiring security in a specific area of a memory, and
wherein the main OS cannot access the specific area of the memory in which the secure OS processes data requiring security.

3. The secure data processing device of claim 1, wherein each of the plurality of main processes is at least one of a decryption process for decrypting content, a decoding process for decoding the content, a rendering process for outputting the content, and a User Interface (UI) process for providing the content to a user.

4. The secure data processing device of claim 1, wherein the at least one secure process is at least one of a decryption process for decrypting content, a decoding process for decoding the content, a rendering process for outputting the content, and a UI process for providing the content to a user.

5. The secure data processing device of claim 1, further comprising a secure communication unit for enabling switching between a normal mode in which the secure data processing device is executed by the main OS and a secure mode in which the secure data processing device is executed by the secure OS.

6. The secure data processing device of claim 1, further comprising a secure communication unit for enabling switching between a normal mode in which the secure data processing device is executed by the main OS and a secure mode in which the secure data processing device is executed by the secure OS,
wherein the secure communication unit separates a memory area accessible by the main OS and a memory area accessible by the secure OS in a hardware manner, using a predetermined bit.

7. A secure data processing method comprising:
detecting by a main Operating System (OS) that a first main process is operating abnormally, among a plurality of main processes which are executed under control of the main OS and which are associated with a secure OS that is simultaneously operated with the main OS; and
interrupting and initializing an operation of at least one secure process which is executed under control of the secure OS that is simultaneously operated with the main OS, and which corresponds to at least one of the plurality of main processes.

8. The secure data processing method of claim 7, further comprising interrupting and initializing an operation of the plurality of main processes with the exception of the first main process.

9. The secure data processing method of claim 7, further comprising notifying, by the main OS, the abnormal operation of the first main process to the plurality of main processes with the exception of the first main process.

10. The secure data processing method of claim 9, further comprising requesting the main OS to interrupt and initialize the secure processes by any one of the plurality of main processes with the exception of the first main process.

11. The secure data processing method of claim 7, wherein the secure OS processes data requiring security in a specific area of a memory, and
wherein the main OS cannot access the specific area of the memory in which the secure OS processes data requiring security.

12. The secure data processing method of claim 7, wherein each of the plurality of main processes is at least one of a decryption process for decrypting content, a decoding process for decoding the content, a rendering process for outputting the content, and a User Interface (UI) process for providing the content to a user.

13. The secure data processing method of claim 7, wherein the at least one secure process is at least one of a decryption process for decrypting content, a decoding process for decoding the content, a rendering process for outputting the content, and a UI process for providing the content to a user.

14. The secure data processing method of claim 7, further comprising enabling switching between a normal mode in which the secure data processing method is executed by the main OS and a secure mode in which the secure data processing method is executed by the secure OS.

15. The secure data processing method of claim 7, further comprising enabling switching between a normal mode in which the secure data processing method is executed by the main OS and a secure mode in which the secure data processing method is executed by the secure OS,
wherein a memory area accessible by the main OS and a memory area accessible by the secure OS are separated in a hardware manner, using a predetermined bit.
